(19) United States
(12) Patent Application Publication
(10) Pub. No.: US 2010/0127676 A1
(43) Pub. Date: May 27, 2010

(54) POWER SOURCE APPARATUS

(75) Inventors: Kazuo Yamazaki, Kanagawa (JP); Yukihiro Terada, Kanagawa (JP); Kouji Murakami, Fukuoka (JP); Tamiji Nagai, Tokyo (JP); Toshio Nagai, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co. Ltd., Tokyo (JP)

(21) Appl. No.: 12/439,354

(22) PCT Filed: Aug. 28, 2007
(86) PCT No.: PCT/JP2007/066587

§ 371 Date: Feb. 27, 2009

(30) Foreign Application Priority Data
Aug. 30, 2006 (JP) 2006-233651

(51) Int. Cl. G05F 1/00

(52) U.S. Cl. 323/282; 323/265

(57) ABSTRACT

Disclosed is a power source apparatus including: a connector for outputting electric power, wherein the apparatus performs power output through a cable connected to the connector, a power source circuit capable of changing an output thereof; a control circuit to perform output control of the power source circuit; and a first detection circuit including an input terminal for detection connected to wiring on a side of a tip of the cable to perform detection pertaining to an output quantity of electric power, wherein the output control is performed based on a detection signal of the first detection circuit, the detection signal fed back to the control circuit.

### TECHNICAL FIELD

The present invention relates to a power source apparatus, such as an AC adaptor, to perform power output through a cable.

### BACKGROUND ART

There is a power source apparatus, such as an AC adaptor, to generate a predetermined DC power from an AC power source to supply the generated DC power to an external apparatus through a cable. A general AC adaptor is configured so as to detect the output voltage and output current thereof on the side of the adaptor main body to perform the output control thereof.

### DISCLOSURE OF THE INVENTION

### Problem to be solved by the Invention

However, in a power source apparatus to supply DC power to an external apparatus through a cable, the supplied voltage thereof somewhat falls owing to the wiring resistance of the cable and the contact resistance of a connector. Moreover, the fall of the output voltage disperses according to the magnitude of the output current and the connected state of the connector and is not constant.

Accordingly, it is general for a conventional system to set the output voltage of the AC adaptor to be a little higher than a predetermined voltage so that an apparatus to receive power supply may drop the output voltage to a necessary voltage with a regulator circuit to use the dropped voltage on the apparatus side if the apparatus needs an accurate power source voltage.

Moreover, in recent years, it is considerable that the accurate control of the supply voltage from the AC adaptor becomes more difficult owing to the recent requirements to the AC adaptor for a portable telephone such as thinning the power supply line thereof to increase the flexibility of the cable thereof and miniaturizing the connector thereof.

The present invention is directed to provide a power source apparatus capable of supplying accurate electric power even if the resistance of its power supply line and the contact resistance of its connector exist.

According to a first aspect of the present invention, there is provided a power source apparatus (10: FIG. 1) including a connector for power output, the apparatus performing the power output through a cable connected to the connector, the apparatus including: a power source circuit (11) capable of changing an output thereof; a control circuit (12) to perform output control of the power source circuit; and a first detection circuit (14) including an input terminal for detection connected to wiring on a side of a tip of the cable to perform detection pertaining to an output quantity (for example, a voltage detection or a current detection) of electric power, wherein the output control is performed based on a detection signal of the first detection circuit, the detection signal fed back to the control circuit.

Preferably, the first detection circuit is disposed on the side of the tip of the cable or in the connector.

According to such an aspect, the detection for the output control is performed on the tip side of the cable. Consequently, even if the wiring resistance of the cable is large, the accurate output control excluding the influences of the wiring resistance can be performed. The wiring resistance is also added to the detection line of the first detection circuit and the output line of a detection signal, but the currents flowing through the detection line and the output line of the detection signal can be miniaturized to a neglectable degree in comparison with the current flowing through the wiring for power output. Consequently, no errors are caused in the output control owing to the wiring resistance. Thus, accurate power supply can be performed to an external apparatus to be connected, and it becomes possible to use the output of the power source apparatus directly as a power source voltage without the necessity of providing a regulator circuit or the like into the external apparatus.

According to a second aspect of the present invention, there is provided a power source apparatus (10A: FIG. 3) including a connector for power output, the apparatus performing the power output through a cable connected to the connector, the apparatus comprising: a power source circuit (11) capable of changing an output thereof; a control circuit (12) to perform output control of the power source circuit; a first detection circuit (14a) to perform detection pertaining to an output quantity (for example, a voltage detection or a current detection) of electric power to feed back a detection signal to the control circuit; and a control connection terminal (T2) provided in the connector, the control connection terminal connected to an input terminal for detection of the first detection circuit, wherein a voltage at a predetermined node of an external apparatus connected to the power source apparatus through the control connection terminal is input into the first detection circuit, and the output control of the control circuit is performed based on the detection signal of the first detection circuit. Here, preferably, the first detection circuit is disposed on a side of a tip of the cable.

According to such an aspect, since the detection point of the output quantity of the power source apparatus can be set at the node of a power source line or the like on the side of the external apparatus, the accurate output control of the power source apparatus excluding the influences of the wiring resistance of the cable and the contact resistance of the connector can be performed.

Preferably, the power source apparatus further includes: a switch circuit (SW1) to switch a connection of the input terminal for detection of the first detection circuit (14a: FIG. 5) between the control connection terminal (T2) and wiring (N1) for power output; and a connection detection circuit (18) to detect a connection of the connector to the external apparatus, wherein the input terminal for detection is switched to a side of the control connection terminal by the switch circuit when the connection of the external apparatus is detected, and the input terminal for detection is switched to the wiring for power output by the switch circuit when the connection of the external apparatus is not detected.

By such a configuration, the abnormal rising and instability of the output of the power source apparatus owing to the inexistence of any detection signals at the time of no connection of any external apparatus can be prevented.

Preferably, the power source apparatus further includes a second detection circuit (20: FIG. 7, FIG. 8) to perform detection pertaining to the output quantity of the electric power on a side of a main body of the power source apparatus in relation to the cable, wherein the control circuit (12) performs the output control by using the detection signal of the first detection circuit (14a) with priority to a detection signal of the second detection circuit when the detection signal of the first detection circuit exists.

By such a configuration, the output control based on the detection of the predetermined node in the external apparatus is performed when the external apparatus is connected to the power source apparatus, and the output control based on an internal detection signal is performed when no external output apparatus is connected to the power source apparatus. Consequently, the abnormal rising and instability of the output of the power source apparatus owing to no existence of detection signals can be prevented.

Preferably, the power source apparatus further includes a switch circuit (21: FIG. 7) to transmit the detection signal of the first detection circuit to the control circuit when the detection signal of the first detection circuit exists, and to transmit the detection signal of the second detection circuit to the control circuit when the detection signal of the first detection circuit does not exists.

Alternatively, the first detection circuit (14a: FIG. 8) and the second detection circuit (20) are configured to displace the detection signals from a reference value when detection values pertaining to the output quantity of the electric power exceed respective set values (V1, V2) of the first and second detection circuits, and the set values of the first and second detection circuits are set to satisfy the following relation: (the set value of the first detection circuit)<(the set value of the second detection circuit).

By such a configuration, the control circuit can use the detection signal of the first detection circuit with priority to the detection signal of the second detection circuit to perform the output control of the power source apparatus.

Preferably, the power source apparatus further includes: a third detection circuit (14b: FIG. 10) having an input terminal for detection, the input terminal connected to the control connection terminal; a switch circuit (24) to switch a connection of the control circuit between outputs of the first and third detection circuits selectively to transmit a selected output to the control circuit; a second detection circuit (20) to perform detection pertaining to the output quantity of the electric power to output a detection signal to the control circuit; a stop circuit (26) capable of stopping/continuing output of the second detection circuit; and a control section to detect existence of the output of the switch circuit to perform operation control of the stop circuit and the switch circuit, wherein the first to third detection circuits are configured to displace their output values from a reference value when detection values pertaining to the output quantity of the power exceed respective set values of the first to third detection circuits, and the set values are set to satisfy the following relation: (the set value (71) of the first detection circuit)>(the set value (V2) of the second detection circuit)>(the set value (V3) of the third detection circuit).

Preferably, the control section stops the stop circuit (26) to continue the output of the second detection circuit (20), and switches the switch circuit (24) to a side of the third detection circuit (14b) when the output of the switch circuit (24) does not exist, and the control section makes the stop circuit (26) operate to stop the output of the second detection circuit (20), and switches the switch circuit (24) to a side of the first detection circuit (14a) when the output of the switch circuit (24) exists.

According to such an aspect, when no external apparatus are connected to the power source apparatus, the output control of the power source apparatus based on the detection signal of the second detection circuit is performed, and the output voltage of the power source apparatus can be arbitrarily set to, for example, a lower output voltage and an output voltage by which the standby power of the power source apparatus becomes the minimum. Moreover, when an external apparatus is connected to the power source apparatus, the output control of the power source apparatus based on the detection signal of the second detection circuit is switched to the output control of the power source apparatus based on the detection signal of the first detection circuit by the operation of the third detection circuit, and consequently necessary power output can be performed.

Preferably, the power source apparatus further includes a detection circuit (15: FIG. 4) for protection to perform detection pertaining to the output quantity of the electric power on the side of the main body in relation to the cable, wherein the control circuit stops or lowers the output from the power source circuit when the detection circuit for protection detects the output quantity equal to or more than a predetermined output quantity.

By adding such a configuration, it can be performed to protect the power source apparatus lest its output should exceed rated power.

Incidentally, although the marks indicating the correspondence relations with embodiments have been shown in parentheses in the description in this clause, the present invention does not restricted to those indicated components of the embodiments.

According to the present invention, the following advantages can be obtained. That is, a power source apparatus can supply accurate electric power to a connected external apparatus even if a relatively large wiring resistance exists in a cable for outputting the electric power and even if a connection resistance exists in a connector of the power source apparatus. Moreover, as the result, even if the external apparatus requires an accurate power source voltage or an accurate power source current, the power source apparatus can enable the external apparatus to use the supplied electric power from the power source apparatus directly without any necessity of being provided with a regulator circuit for adjusting the power source voltage.

### BRIEF DESCRIPTION OF DRAWINGS

FIG. 1 This is a block diagram showing the configuration of an AC adaptor according to a first embodiment of the power source apparatus of the present invention.

FIG. 2 This is a graph showing an output characteristic of the detection circuit shown in FIG. 1.

FIG. 3 This is a block diagram showing the configuration of an AC adaptor 10A of a second embodiment of the present invention.

FIG. 4 This is a block diagram showing the configuration of an AC adaptor 10B of a third embodiment.

FIG. 5 This is a block diagram showing the configuration of an AC adaptor 10C of a fourth embodiment.

FIG. 6 This is a circuit diagram showing the concrete circuit examples of the connection detection circuit and the switch circuit shown in FIG. 5.

FIG. 7 This is a block diagram showing the configuration of an AC adaptor 10D of a fifth embodiment.

FIG. 8 This is a block diagram showing a modification of the AC adaptor 10D of the fifth embodiment.

FIG. 9 This shows a graph of output characteristics of the first detection circuit 14a and the second detection circuit 20 shown in FIG. 20.

FIG. 10 This is a block diagram showing the configuration of an AC adaptor 10E of a sixth embodiment.

FIG. 11 This is a block diagram showing the configuration of the AC adaptor 10F of a seventh embodiment.

10, 10A-10F AC adaptor
11 SW power source circuit
12 control circuit
13 detection receiving circuit
14, 14a detection circuit
h1 power supplying line
h2 ground line
h3 detection signal line
R1-R3 wiring resistances
T0, T1 power source output terminal
T2 control connection terminal
15 detection circuit for protection
16 stop control circuit
SW1 switch circuit
18 connection detection circuit
20 second detection circuit
21 switch circuit
21a adding circuit
24 switch circuit
26 stop circuit

### BEST MODE FOR CARRYING OUT THE INVENTION

In the following, the preferred embodiments of the present invention will be described with reference to the attached drawings.

### First Embodiment

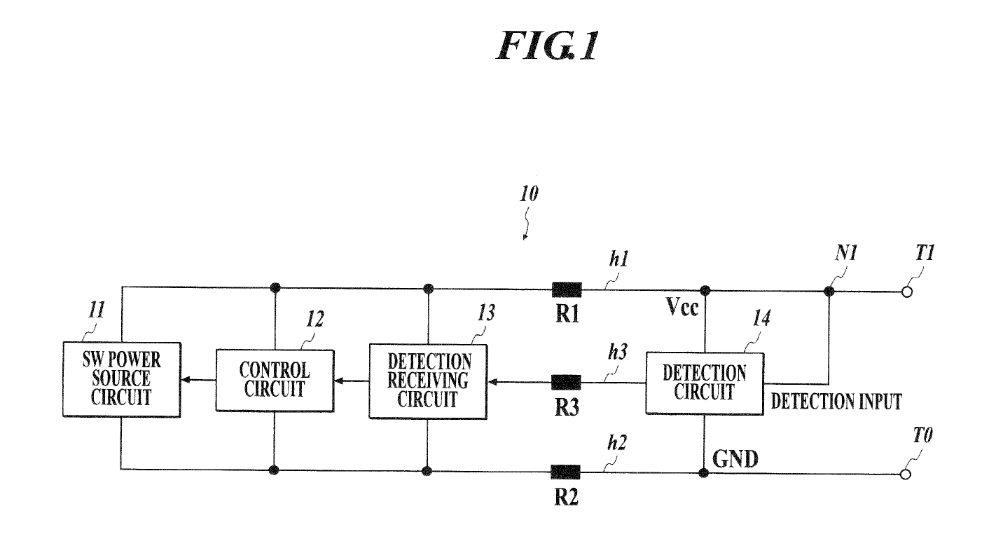

FIG. 1 is a block diagram showing the configuration of an AC adaptor according to a first embodiment of the power source apparatus of the present invention.

The AC adaptor 10 of the present embodiment is a power source apparatus connected to a piece of set equipment, such as a portable telephone, through a connector to supply electric power to the set equipment through a cable.

The AC adaptor 10 is equipped with a SW power source circuit 11, a control circuit 12, a detection circuit 14, and a detection receiving circuit 13. The SW power source circuit 11 receives the input of AC power to perform current output controlled by a switching operation of a transistor. The control circuit 12 changes the switching frequency of the SW power source circuit 11 and changes the on-period of the switching element of the SW power source circuit 11 to perform the output control of the SW power source circuit 11. The detection circuit 14 detects the output voltage and the like of the AC adaptor 10 for the output control thereof to feed back the detected signal. The detection receiving circuit 13 is, for example, a reception buffer to receive the detection signal from the detection circuit 14 to output the received detection signal to the control circuit 12.

The AC adaptor 10 is composed of an adaptor main body section mounted with the SW power source circuit 11, a cable for supplying electric power, which cable extends from the adaptor main body section, and a connector provided at the tip of the cable. A power supplying line h1, a ground line h2, and a control signal line h3 are wired in the cable, and wiring resistances R1-R3 are added to the lines h1-h3, respectively. Moreover, power source output terminals T0 and T1 are provided to the connector.

The detection circuit 14 is disposed on the tip side of the cable for supplying electric power (or in the connector) and is configured to perform the detection of the output voltage of the AC adaptor 10 at a node N1 near to the output terminal T1 of the power supplying line h1 as a detection point.

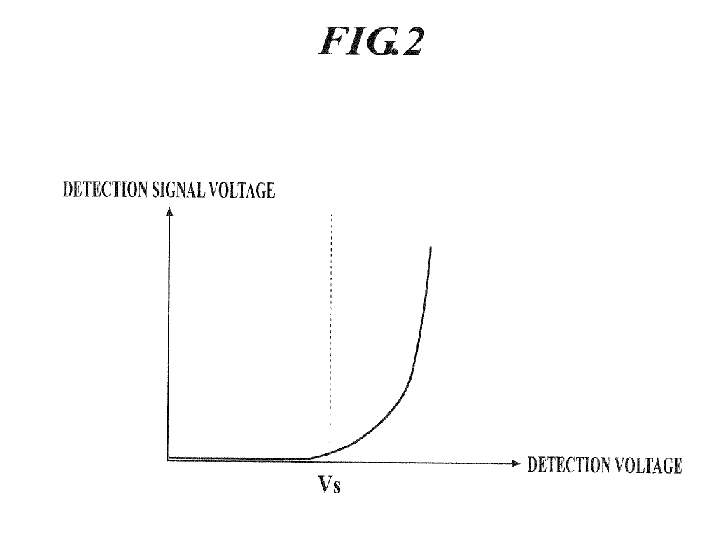

FIG. 2 shows an output characteristic graph of the detection circuit.

The detection circuit 14 divides the voltage at an input terminal for detection with, for example, dividing resistors and compares the divided voltage with a reference voltage. Then the detection circuit 14 amplifies the voltage difference between the divided voltage and the reference voltage with an error amplifier to output the amplified voltage difference. Then, as shown in FIG. 2, the detection circuit 14 has an output characteristic as follows: the detection output thereof is set to a reference value (for example, of a voltage value of zero) when the divided voltage is lower than the reference voltage; the detection output is raised when the divided voltage becomes in the neighborhood of the reference voltage; and the detection output is heightened according to the voltage difference between the divided voltage and the reference voltage when the divided voltage exceeds the reference voltage. The set voltage Vs at which the detection output has risen to reach a constant value can be arbitrarily selected by selecting the division ratio of the dividing resistors.

The control circuit 12 increases the output of the SW power source circuit 11 when a detection signal fed back is the reference value. On the other hand, when the detection signal fed back becomes larger than a predetermined voltage, the control circuit 12 lessens the switching frequency of the SW power source circuit 11 or shortens the on-period of the switching element thereof by the amount of the excess of the detection signal over the predetermined voltage, and the control circuit 12 thereby reduces the output of the SW power source circuit 11. The control circuit 12 performs the output control of the AC adaptor 10 so as to keep the voltage at the detection point of the detection circuit 14 to the set voltage Vs.

According to the AC adaptor 10 having the configuration mentioned above, since the detection point of the detection circuit 14 is set on the tip side of the cable, even it the wiring resistances R1 and R2 of the power supplying line h1 and the ground line h2, respectively, become comparatively larger, accurate power output without the influences of the increase of the wiring resistances R1 and R2 can be performed. Although the control signal line h3 includes the wiring resistance R3 similarly, the current flowing through the detection circuit 14 can be set to be a very small value in comparison with the current of the power supplying line h1, and consequently the influences of the wiring resistance R3 can be reduced to a negligible level.

Consequently, accurate power supply to a connected external apparatus can be performed, and even if the external apparatus requires an accurate power source voltage or an accurate power source current, it is possible to enable the external apparatus to use the supplied electric power from the AC adaptor 10 directly. Thus an advantage of no necessity of providing any regulator circuit to the apparatus to which the electric power is supplied can be obtained.

Incidentally, although the detection circuit 14 is provided on the tip side of the cable, a similar advantage can be obtained by the configuration in which the detection circuit 14 is provided on the adaptor main body side and the input terminal for detection of the detection circuit 14 is connected to the node N1 on the side of the output terminal T1 of the power source supplying line h1 though the signal control line h3.

### Second Embodiment

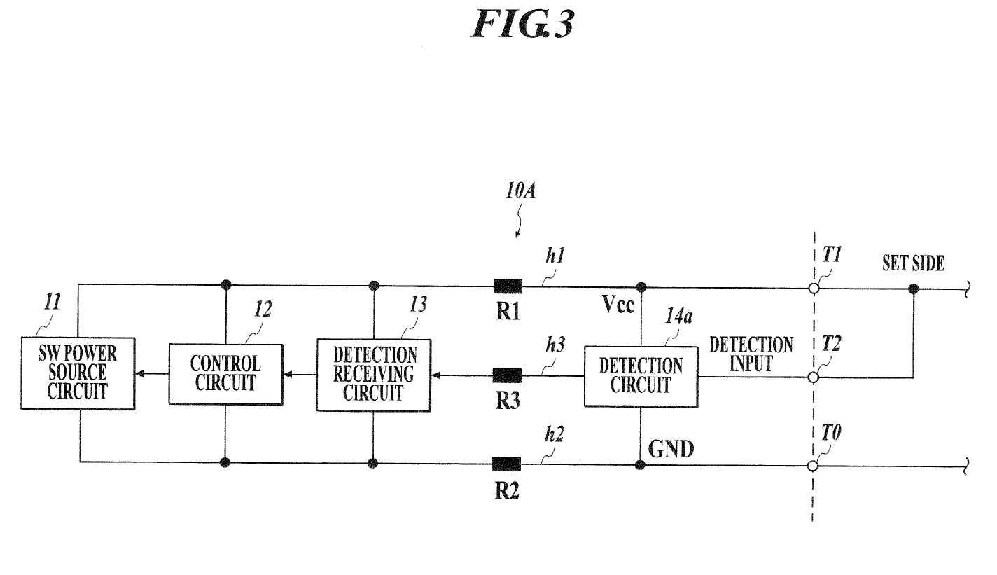

FIG. 3 is a block diagram showing the configuration of an AC adaptor 10A of a second embodiment of the present invention.

The AC adaptor 10A of the second embodiment adds a control connection terminal T2 to the connector to be connected to an external apparatus, and the detection input terminal for detection of a detection circuit 14a is connected to the control connection terminal T2 to perform the output control of the SW power source circuit 11 based on the detection of an arbitrary node in the external apparatus.

The detection circuit 14a keeps its detection output to a reference value (for example, a voltage value of zero) when the voltage at the input terminal for detection is lower than a predetermined reference voltage (for example 1V); raises the detection output from the reference value when the voltage at the input terminal for detection becomes in the neighborhood of the reference voltage; and heightens the detection output by the amount of excess of the detection output over the reference voltage when the voltage at the input terminal exceeds the reference voltage.

Moreover, the control circuit 12 receives the detection output to perform the control of increasing and decreasing the output quantity of the SW power source circuit 11 similarly to the first embodiment.

In such a configuration, for example, if a predetermined set voltage (for example, 6V) is necessary at an arbitrary node of the power source line of an external apparatus, then the external apparatus is configured in advance so as to be provided therein with division resistors to divide the voltage at the node to drop the voltage to the reference voltage (1 V), and is further configured so that the division point of the division resistors may be connected to the control connection terminal T2. Thereby, the AC adaptor 10A can perform necessary output control to enable to supply the stable and accurate set voltage (6 V) to the node of the external apparatus.

Moreover, if the external apparatus needs a predetermined set current at a certain node on the power source line, then the external apparatus is configured in advance so as to be provided therein with a resistor to convert the current flowing the node into a voltage, a circuit to amplify the voltage on both the ends of the resistor up to the reference voltage (1 V), and the like, and further is configured so that the output terminal of the circuit may be connected to the control connection terminal T2. Thereby, the AC adaptor 10A performs needed output control to enable to supply the stable and accurate set current to the node of the external apparatus.

As described above, according to the AC adaptor of the present embodiment, since it is possible to set the detection point of a voltage or current by the detection circuit 14a at an arbitrary node in the external apparatus of a connection destination, an accurate voltage or current can be supplied to the external apparatus with the influences of the wiring resistances R1-R3 of the cable and the contact resistances of the connection terminals T0 and T2 excluded, even if these resistances exist.

Incidentally, also in the present embodiment, the detection circuit 14a may not be provided on the tip of the cable, but may be configured to be provided on the adaptor main body side and to extend the signal line of the control connection terminal T2 to connect the signal line to the input terminal for detection of the detection circuit 14a.

### Third Embodiment

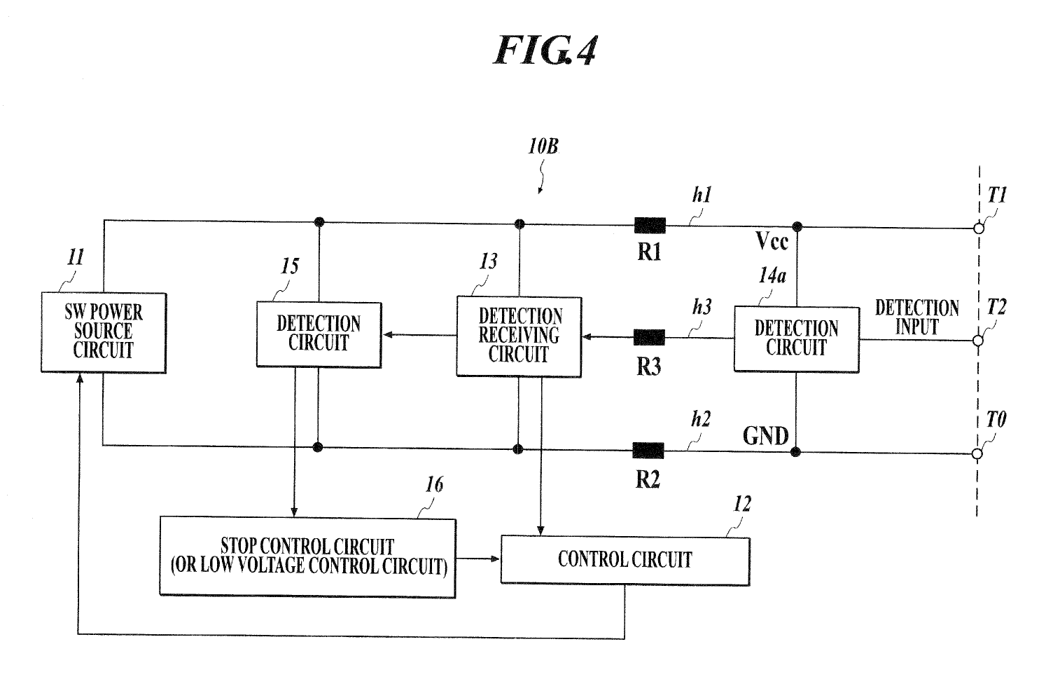

FIG. 4 is a block diagram showing the configuration of an AC adaptor 10B of a third embodiment.

The AC adaptor 10B of the third embodiment is provided with a detection circuit 15 for protection and a stop control circuit 16 for protection in order not to exceed a rated output in addition to the configuration of the second embodiment.

The detection circuit 15 for protection is disposed on the side of the adaptor main body, and is configured so as to raise a detection output when the output voltage or output current of the AC adaptor 103 exceeds the rated voltage or rated current of the AC adaptor 103, respectively.

The stop control circuit 16 is configured to receive the output of the detection circuit 15, and to output a signal for stopping output to the control circuit 12 when the received output exceeds a predetermined threshold value. Moreover, the stop control circuit 16 is configured to continue to output the signal for stopping output until the input of AC electric power is broken to reset the circuit when the stop control circuit 16 has once output, the signal for stopping output.

When the control circuit 12 receives the input of the signal for stopping output from the stop control circuit. 16, the control circuit 12 controls the SW power source circuit 11 so as to stop the power output thereof or so as to output a lower voltage regardless of the magnitude of the detection signal.

By such a configuration, it is possible to protect the external apparatus and the internal circuits of the AC adaptor 10B by stopping the output thereof or by lowering the output voltage thereof within a range of not exceeding the rated output even if the output voltage or output current thereof abnormally rises owing to some defects.

### Fourth Embodiment

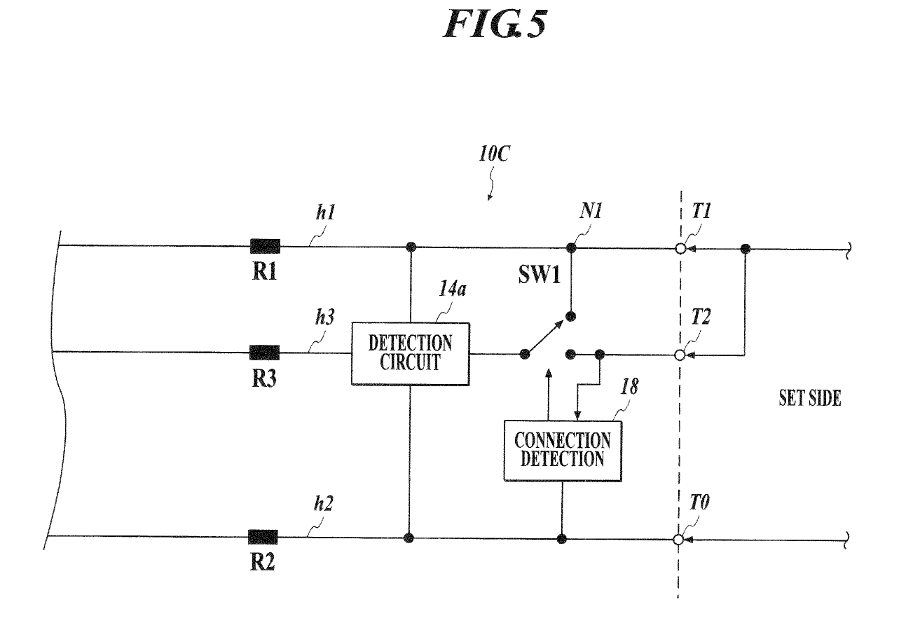

FIG. 5 is a block diagram showing the configuration of an AC adaptor 10C of a fourth embodiment.

The AC adaptor 10C of the fourth embodiment is equipped with a switch circuit S1 to switch the connection of the input terminal for detection of the detection circuit 14a between the control connection terminal T2 and the node N1 of the power source supplying line h1, and a connection detection circuit 18 to detect whether the connector is connected to an external circuit or not in addition to the configuration of the second embodiment, and the AC adaptor 10C is configured to switch the switch circuit SW1 based on a detection result of the connection detection circuit 18.

The connection detection circuit 18 can be configured so as to detect the existence of the connection of the connector circuit to the external circuit by detecting, for example, whether a voltage is applied to the control connection terminal T2 or not. Then, the connection detection circuit 18 is configured to switch the connection of the switch circuit SW1 to the side of the control connection terminal T2 when the connection exists, and to switch the connection of the switch circuit SW1 to the side of the node N1 when there is no connection.

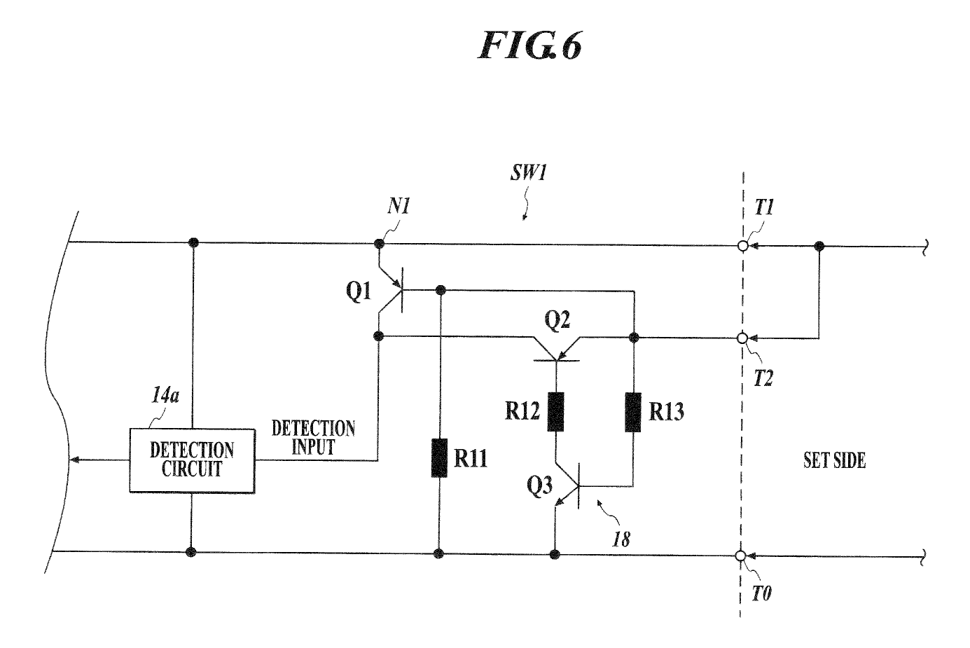

FIG. 6 shows the concrete circuit examples of the connection detection circuit 18 and the switch circuit SW1.

Various systems, such as a contact point system switch and a semiconductor switch, can be applied to the switch circuit SW1. If semiconductor switch is used, for example, bipolar transistors Q1 and Q2, as shown in FIG. 6, can be applied as the switch circuit SW1. That is, the emitter terminal and collector terminal of the transistor Q1 are connected to the node N1 and the input terminal for detection of the detection circuit 14a, respectively, and consequently the turning on and off of the transistor Q1 are enabled by the base voltage. Moreover, the emitter terminal and collector terminal of the transistor Q2 are connected to the control connection terminal T2 and the input terminal for detection of the detection circuit 14a, respectively, and consequently the turning on and off of the transistor Q2 are enabled by the base voltage.

Moreover, the connection detection circuit 18 can be configured with a bipolar transistor Q3 connected between the base of the transistor Q2 and the ground. The base of the transistor Q3 is connected to the control connection terminal T2.

By such a configuration, when a voltage is applied to the control connection terminal T2, the transistor Q3 is tuned on to turn on the transistor Q2 in the switch circuit SW1. Thereby, the input terminal for detection of the detection circuit 14a can be switched to the side of the control connection terminal T2. Moreover, when no voltages are applied to the control connection terminal T2, the transistor Q3 is turned off to turn on the transistor Q1 in the switch circuit SW1. Thereby, the input terminal for detection of the detection circuit 14a can be switched to the side of the node N1.

According to the AC adaptor 10C configured as described above, when an external apparatus is connected thereto, the detection circuit 14a performs the detection of a predetermined node in the external apparatus through the control connection terminal T2, and the output control of the AC adaptor 10C can be performed based on the detection output of the detection circuit 14a. On the other hand, when the connection of the external apparatus is taken off, the control terminal of the detection circuit 14a is connected to the node N1 of the power source supplying line h1. Consequently, the disadvantages such as the abnormal rising of the output voltage of the AC adaptor 10C and the instability of output voltage can be avoided.

Incidentally, the concrete configurations of the switch circuit SW1 and the connection, detection circuit 18 are not restricted to those shown in the circuit diagram of FIG. 6, but any circuit configuration may be applicable as long as the circuit configuration can realize the operations described above.

### Fifth Embodiment

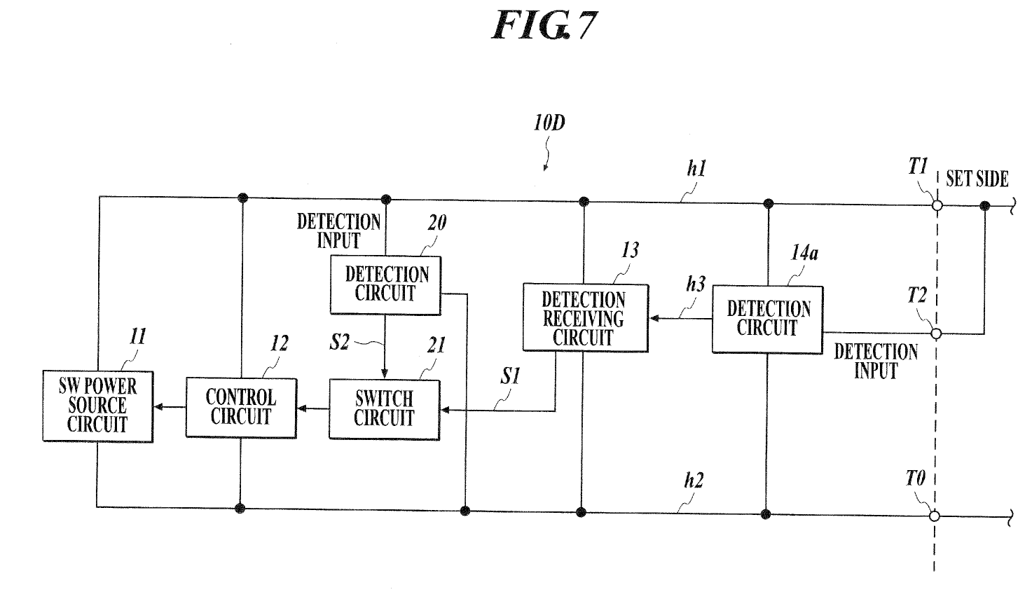

FIG. 7 is a block diagram showing the configuration of an AC adaptor 10D of a fifth embodiment.

The AC adaptor 10D of the fifth embodiment is further configured so as to transmit a detection signal from a second detection circuit 20 to the control circuit 12 to stabilize the power output of the AC adaptor 10D when the output of the first detection circuit 14a does not exist by the taking-off of the connection with an external apparatus, in addition to the configuration of the second embodiment.

Accordingly, the AC adaptor 10D is equipped with a the second detection circuit 20, which is provided in the adaptor main body to detect the output voltage thereof to output a second detection signal S2, and a switch circuit 21 to switch the output signal thereof between a detection signal S1 of the first detection circuit 14a and a detection signal S2 of the second detection circuit 20 to output the switched detection signal to the control circuit 12.

The switch circuit 21 receives the two detection signals S1 and S2 to output either of them to the control circuit 12, and is configured so as to operate to output the detection signal S1 preferentially when the input of the detection signal S1 from the first detection circuit 14a exists.

According to such a configuration, when an external apparatus is connected to the AC adaptor 10D, the output control of the AC adaptor 10D is performed based on the detection signal S1 of the detection circuit 14a to enable the accurate power supply. On the other hand, when the connection of the external apparatus is taken off, the detection signal S2 of the second detection circuit 20 is transmitted to the control circuit 12, and consequently the disadvantages of the abnormal rising and instability of the output of the SW power source circuit 11 owing to the inexistence of any detection, signals can be avoided.

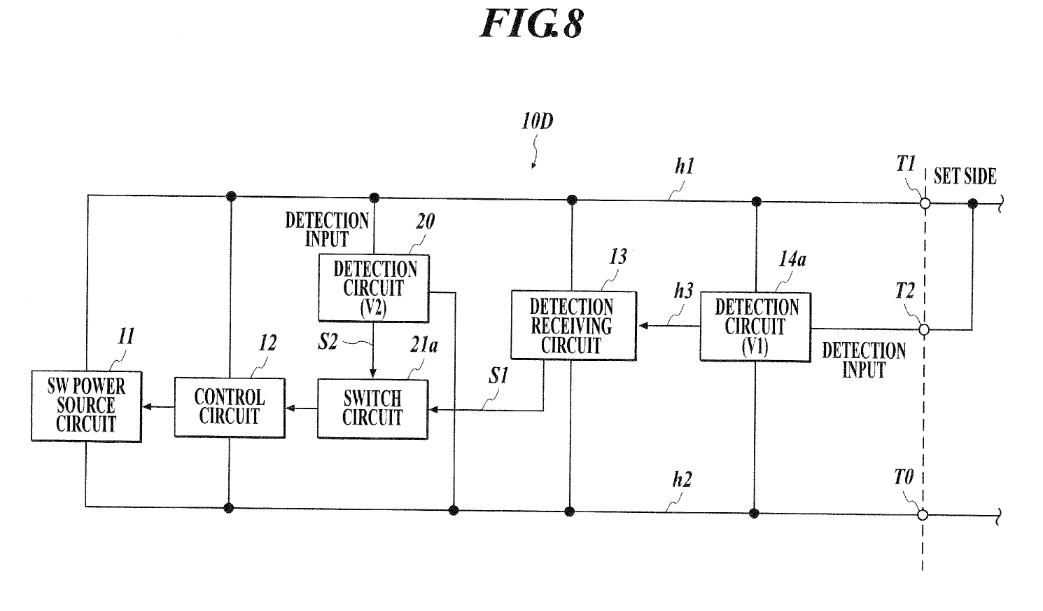

FIG. 8 shows a modification of the AC adaptor 10D of the fifth embodiment.

Several patterns of the switch circuits can be applied to the configuration of the switch circuit 21 of the fifth embodiment. For example, one of the patterns of the switch circuits is a circuit of detecting the existence of the first detection signal S1 to switch the connection of the signal lines based on the detection result, and another of the pattern of the switch circuits is a configuration as an addition circuit 21a shown in FIG. 8. Next, the case of the configuration as the addition circuit 21a will be described.

The addition circuit 21a is a circuit to add the voltage values of two analog signals to output the added voltage value. To put it concretely, the addition circuit 21a may be a circuit using an operational amplifier to add the voltages, or may be a circuit including only resistors to add the voltages without using any operational amplifiers because the addition values do not need to be pretty accurate.

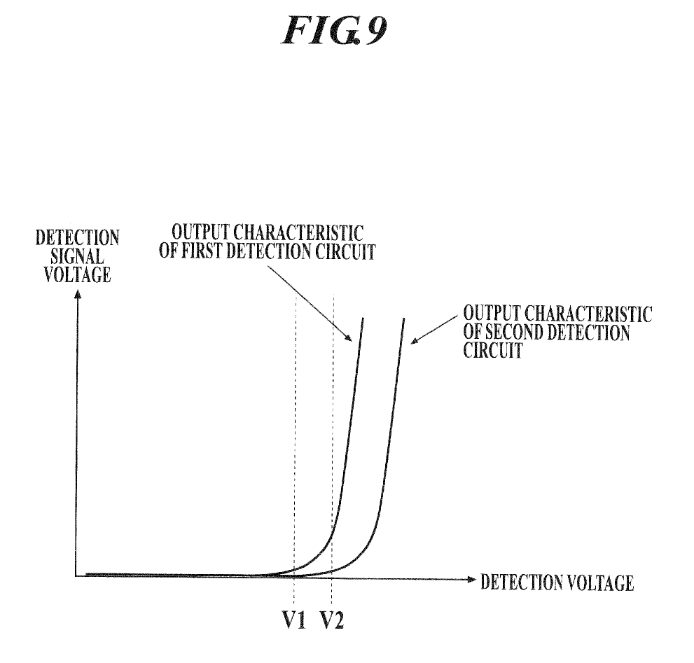

FIG. 9 shows a graph of output characteristics of the first detection circuit 14a and the second detection circuit 20.

Moreover, if the addition circuit 21a is used, it is required to set the output characteristics of the first and second detection circuits 14a and 20 to predetermined characteristics. That is, the characteristics are set as follows. First, as shown in FIG. 9, the output characteristics of the first and second detection circuits 14a and 20 set their outputs to a reference value (for example, a voltage value of zero) in the range of the detection voltages being less than the set voltages V1 and V2, respectively. The output characteristics raise the output values when the detection voltages approach the set values, and raise the output values by the excesses of the detection voltages over the set voltages V1 and V2 when the detection voltages exceed the set voltages V1 and V2, respectively. Furthermore, the set voltage V2 of the second detection circuit 20 is previously set to be a value larger than the set voltage V1 of the first detection circuit 14a. That is, the set voltages are set to “V2>V1+ΔV” (where ΔV indicates a voltage drop of a wiring resistance, a connector contact resistance, and the circuits between them).

By setting the set voltages V1 and V2 as above, when the output voltage detection voltage) of the AC adaptor 10D is becoming larger, the detection signal S1 of the first detection circuit 14a rises first to be output to the control circuit 12 through the addition circuit 21a. Then, the control to suppress the output voltage is performed based on the detection signal S1, and the output voltage is stabilized in the neighborhood of the set voltage V1 of the first detection circuit 14a.

At this time, since the output voltage of the AC adaptor 10D is kept at a voltage lower than the set voltage V2 of the second detection circuit 20, the detection signal S2 of the second detection circuit 20 becomes almost zero, and the output of the addition circuit 21a is substantially the same value of the output value of the first detection circuit 14a. Consequently, the addition circuit can be regarded as the circuit to output the detection signal of the first detection circuit 14a preferentially.

On the other hand, if the external apparatus is taken off, then the output of the first detection circuit 14a becomes nonexistent, and consequently the output voltage of the AC adaptor 10D rises and also the detection signal S2 of the second detection circuit 20 rises. Then, the detection signal S2 is output to the control circuit 12 through the addition circuit 21a, and the output control based on the detection signal S2 is performed. Then, the output voltage of the AC adaptor 10D is stabilized in the neighborhood of the set voltage V2.

As described above, the AC adaptor 10D can be configured as follows. That is, when the detection signal S1 of the first detection circuit 14a exists, the output control based on the detection signal S1 is preferentially performed. When the detection signal S1 of the first detection circuit 14a does not exist, the output control based on the detection signal S2 of the second detection circuit 20 is performed. Then, by such output control, the advantage capable of avoiding the disadvantage of the abnormal rising and instability of the output of the SW power source circuit 11 owing to the inexistence of any detection signals even when the connection of the external apparatus is taken off.

### Sixth Embodiment

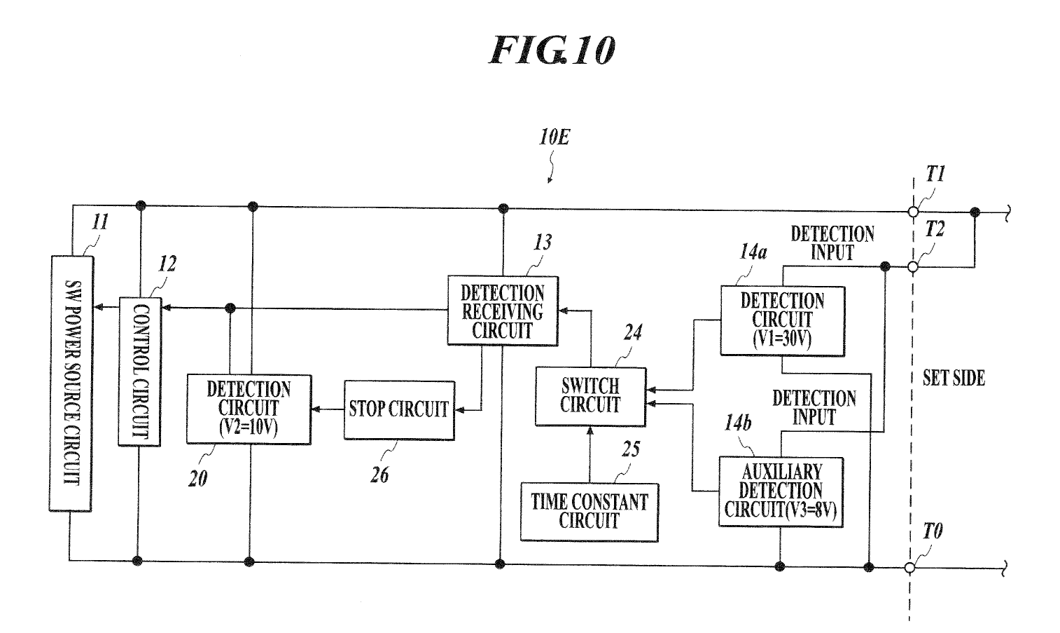

FIG. 10 is a block diagram showing the configuration of an AC adaptor 10E of a sixth embodiment.

The AC adaptor 10E of the sixth embodiment is configured so as to supply a high voltage, such as 30 V, when an external apparatus is connected, and so as to set its output voltage to a low voltage, such as 10 V, when the connection of the external apparatus is taken off.

The aforesaid configuration of FIG. 8 can stabilize the output voltage of the AC adaptor 10D by performing the output control thereof based on the detection signal S2 of the second detection circuit 20 when the external apparatus is taken off, and, on the other hand, the configuration is obliged to set the set voltage V2 of the second detection circuit 20 to be larger than the set voltage V1 of the first detection circuit 14a and consequently the output voltage when the external apparatus is taken off becomes higher. Consequently an AC adaptor for outputting a high voltage has a problem in which the waiting voltage of the AC adaptor when an external apparatus is taken off becomes very high.

The AC adaptor 10E of the sixth embodiment is configured so that the waiting voltage thereof when the external apparatus connected to the AC adaptor 10E is taken off therefrom can be set to a lower voltage even if the AC adaptor 10E is the one for outputting a high voltage.

In order to add the aforesaid function, the AC adaptor 10E of the present embodiment is equipped with an auxiliary detection circuit 14b having an input terminal for detection connected to the control connection terminal T2, a switch circuit 24 to selectively output either of the output of the first detection circuit 14a and the output of the auxiliary detection circuit 14b, a time constant circuit to delay the switching timing, and a stop circuit 26 to stop the operation of the second detection circuit 20 in addition to the first detection circuit 14a having the input terminal for detection connected to the control connection terminal T2 and the second detection circuit 20 to perform the detection of the output voltage of the SW power source circuit 11 in the adaptor main body.

The set voltage of each of the first detection circuit 14a, the second detection circuit 20, and the auxiliary detection circuit 14b is set, as described with regard to the fifth embodiment. Then, the AC adaptor 10E has the output characteristic as follows. That is, when the detection voltage of each of the detection circuits 14a, 20 and 14b is smaller than the corresponding set voltage, the detected output thereof is set to a reference value (for example, a voltage value of zero); when the detection voltage becomes in the neighborhood of the set voltage, the AC adaptor 10E raises its output; and when the detection voltage exceeds the set voltage, the AC adaptor 10E increases its output according to the excess of the detection voltage over the set voltage.

The set voltage V1 of the first detection circuit 14a is set to, for example, 30 V, which is necessary for the apparatus of an output destination, and the set voltage V2 of the second detection circuit 20 is set to 10 V, which is appropriate as a waiting voltage. Moreover, the set voltage V3 of the auxiliary detection circuit 14b is set to, for example, 8 V, which is smaller than the set voltage V2.

Next, the operation of the AC adaptor 10E of the configuration described above will be described.

First, in the state in which no external apparatus are connected to the AC adaptor 10E, there are no detection outputs of the first and auxiliary detection circuits 14a and 14b, and the detection output of the second detection circuit 20 is output to the control circuit 12 and the output control based on the detection output is performed. Consequently, the output voltage of the AC adaptor 10E is controlled to the set voltage V2 (=10V) of the second detection circuit 20.

When an external apparatus is connected to the AC adaptor 10E, an output voltage of 10 V is applied to the input terminal for detection of the auxiliary detection circuit 14b, and consequently the detection output of the auxiliary detection circuit 14b rises. Thus the detection signal is transmitted to the control circuit 12 through the switch circuit 24 and the detection receiving circuit 13. Then, the output control is performed based on the detection signal, and the output voltage of the AC adaptor 10E is dropped to the set voltage V3 (=8 V) of the auxiliary detection circuit 14b.

Moreover, when a detection signal of a predetermined voltage value or more is output from the auxiliary detection circuit 14b, the switch circuit 24 makes the time constant circuit 25 operate, and the detection receiving circuit 13 makes the stop circuit 26 operate to stop the operation of the second detection circuit 20. The detection receiving circuit 13 makes the stop circuit 26 operate to stop the operation of the second detection circuit 20 during a period of the continuation of the input of the detection signal of a certain value or more.

Next, a short delay time has elapsed from the output of the detection signal of the auxiliary detection circuit 14b, a single indicating the elapse of the delay time is output from the time constant circuit 25, and the switch circuit 24 switches the connection thereof from the output of the detection signal of the auxiliary detection circuit 14b to the output of the detection signal of the first detection circuit 14a. Consequently, the detection signal of the first detection circuit 14a is output to the control circuit 12 in the state in which the second detection circuit 20 is in its stop state. Then, the output voltage rises up to the set voltage V1 (=30 V) of the first detection circuit 14a.

Moreover, when the external apparatus is taken off from the AC adaptor 10E in the state of the output of the voltage of 30 V, the output of the first and auxiliary detection circuits 14a and 14b become nonexistent, and the stop control signal output from the detection receiving circuit 13 to the stop circuit 26 is negated. Consequently, the second detection circuit 20 operates to drop the output voltage of the AC adaptor 10E to the set voltage V (=10 V) of the second detection circuit 20.

As described above, according to the AC adaptor 10E of the present embodiment, the following advantages can be obtained. That is, even if no external apparatus are connected to the AC adaptor 10E, a detection signal is output to the control circuit 12 to enable the control circuit 12 to stabilize the output control thereof. Furthermore, the output voltage at the time when no external apparatus are connected to the AC adaptor 10E can be set to a low voltage.

Incidentally, although the AC adaptor 10E has been described as the one for a high voltage output in the above description, the value of the output voltage of the AC adaptor 10E is not especially restricted to the one mentioned above, and also the set voltages V1, V2, and V3 of the detection circuits 14a, 20, 14b, respectively, are not restricted to the concrete values mentioned above. For example, the value of the output voltage of the AC adaptor 10E when no external apparatus are connected thereto can be set to the one which makes the waiting power of the AC adaptor 10E to be the lowest.

### Seventh Embodiment

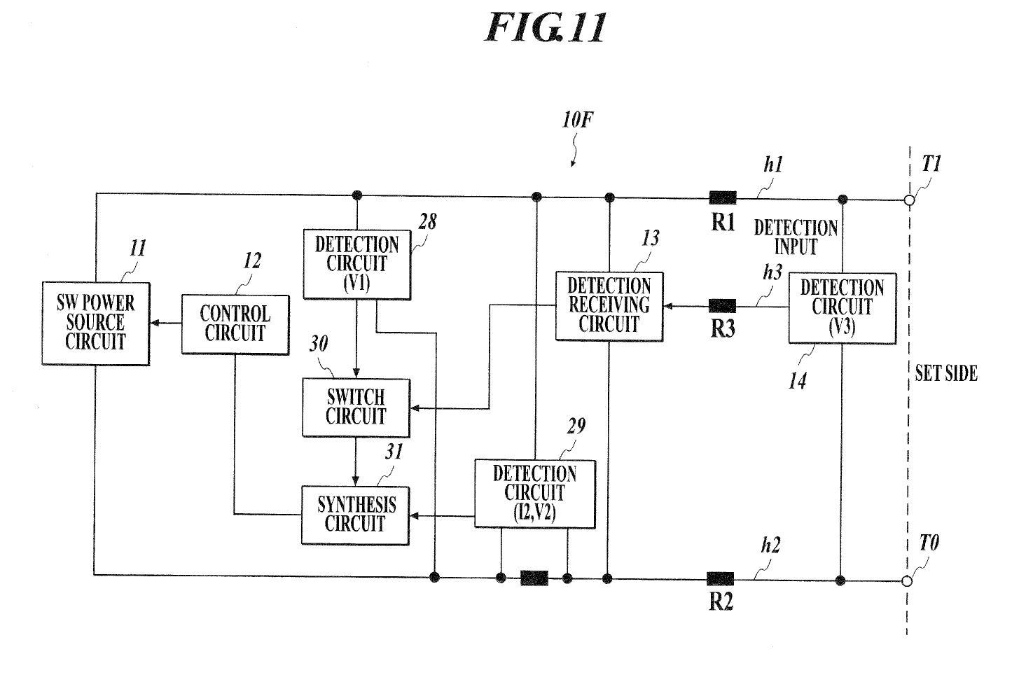

FIG. 11 is a block diagram showing the configuration of the AC adaptor 10F of a seventh embodiment.

The AC adaptor 10F of the seventh embodiment is an example of using the first detection circuit 14 provided in the tip of the cable in the configuration of the first embodiment as a detection circuit for protection (referred to as a second protection detection circuit 14).

The AC adaptor 10F of the present embodiment is equipped with a voltage detection circuit 28 for output control and a first protection detection circuit 29 to perform the detection of the output voltage and output current of the AC adaptor 10F lest the output voltage and the output current should exceed the maximum rated voltage and the maximum rated current, respectively, on the side of the adaptor main body in addition to the configuration of the first embodiment.

Moreover, the AC adaptor 10F is equipped with a switch circuit 30 to switch the detection signal between those of the second protection detection circuit 14 at the tip of the cable and the voltage detection circuit 28 to output the switched detection signal, and a synthesis circuit 31 to perform the synthesis of the detection signals from the switch circuit 30 and the first protection detection circuit 14. The AC adaptor 10F is configured to transmit the output of the synthesis circuit 31 to the control circuit 12 to perform the output control of the AC adaptor 10F.

The voltage detection circuit 28, the first protection detection circuit 29, and the second protection detection circuit 14 are provided with the set voltages V1, V2, and V3, respectively, and severally have an output characteristic, as shown in FIG. 2, in which, when each of the detection signals of the detection circuits 28, 29, and 14 becomes the neighborhood of each of the set voltages V1, V2, and V3 or more, the detection signal is raised.

Each of the set voltages V1, V2, and V3 are set as follows: the set voltage V1 is set to the output voltage at the normal time; the set voltage V2 is set to a value of the maximum rated value satisfying the relation of “V2>V1”; and the set voltage V3 is a value for abnormality protection satisfying the relation of “V3>V2.”

Moreover, each of the switch circuit 30 and the synthesis circuit 31 has a circuit configuration of analogously adding each detection signal together.

According to the AC adaptor 10F configured as above, the output control thereof is performed based on the detection output of the voltage detection circuit 28 at the normal time, and the voltage output at the normal time is performed. But if the power source output terminals T0 and T1 are short-circuited together, or if the voltage detection circuit 28 gets out of order, the detection output of the first protection detection circuit 29 is transmitted to the control circuit 12, and the control of not outputting the output of the AC adaptor 10F exceeding the maximum rated value thereof is performed.

Furthermore, if the first protection detection circuit 29 goes wrong, the second protection detection circuit 14 operates, and the output control of the AC adaptor 10F is performed lest the output voltage thereof should exceed the voltage V3 for protection. Thus double protection can be added lest any excessive voltage should be output to an external apparatus.

Although the best modes of the present invention have been described above, the present invention is not restricted to the first to seventh embodiments. For example, although the AC adaptors receiving AC power to output DC power have been described as the power source apparatus in the embodiments described above, the configuration of the present invention is not restricted to such ones. Moreover, the detailed configurations and operation systems shown in the embodiments can be suitably changed without departing from the spirit and scope of the invention.

The present invention can be applied to a power source apparatus to perform power output through a cable, such as an AC adaptor.

1. A power source apparatus including a connector for power output, the apparatus performing the power output through a cable connected to the connector, the apparatus comprising:
a power source circuit capable of changing an output thereof;
a control circuit to perform output control of the power source circuit; and
a first detection circuit including an input terminal for detection, and connected to wiring on a side of a tip of the cable to perform detection pertaining to an output quantity of electric power, and wherein:
the output control is performed based on a detection signal of the first detection circuit, the detection signal being fed back to the control circuit.

2. The power source apparatus according to claim 1, wherein the first detection circuit is disposed on the side of the tip of the cable.

3. The power source apparatus according to claim 2, wherein the first detection circuit is disposed in the connector.

4. A power source apparatus including a connector for power output, the apparatus performing the power output through a cable connected to the connector, the apparatus comprising:
a power source circuit capable of changing an output thereof;
a control circuit to perform output control of the power source circuit;
a first detection circuit to perform detection pertaining to an output quantity of electric power to feed back a detection signal to the control circuit; and
a control connection terminal provided in the connector, the control connection terminal connected to an input terminal for detection of the first detection circuit, and wherein:
a voltage at a predetermined node of an external apparatus connected to the power source apparatus through the control connection terminal is input into the first detection circuit, and the output control of the control circuit is performed based on the detection signal of the first detection circuit.

5. The power source apparatus according to claim 4, wherein the first detection circuit is disposed on a side of a tip of the cable.

6. The power source apparatus according to claim 4, further comprising:
a switch circuit to switch a connection of the input terminal for detection of the first detection circuit between the control connection terminal and wiring for power output; and
a connection detection circuit to detect a connection of the connector to the external apparatus, and wherein:
the input terminal for detection is switched to a side of the control connection terminal by the switch circuit when the connection of the external apparatus is detected, and the input terminal for detection is switched to the wiring for power output by the switch circuit when the connection of the external apparatus is not detected.

7. The power source apparatus according to claim 4, further comprising a second detection circuit to perform detection pertaining to the output quantity of the electric power on a side of a main body of the power source apparatus in relation to the cable, and wherein:
the control circuit performs the output control by using the detection signal of the first detection circuit with priority to a detection signal of the second detection circuit when the detection signal of the first detection circuit exists.

8. The power source apparatus according to claim 7, further comprising a switch circuit to transmit the detection signal of the first detection circuit to the control circuit when the detection signal of the first detection circuit exists, and to transmit the detection signal of the second detection circuit to the control circuit when the detection signal of the first detection circuit does not exists.

9. The power source apparatus according to claim 7, wherein the first detection circuit and the second detection circuit are configured to displace the detection signals from a reference value when detection values pertaining to the output quantity of the electric power exceed respective set values of the first and second detection circuits, and the set values of the first and second detection circuits are set to satisfy the following relation: (the set value of the first detection circuit)<(the set value of the second detection circuit).

10. The power source apparatus according to claim 4, further comprising:
a third detection circuit having an input terminal for detection, the input terminal connected to the control connection terminal;
a switch circuit to switch a connection of the control circuit between outputs of the first and third detection circuits selectively to transmit a selected output to the control circuit;
a second detection circuit to perform detection pertaining to the output quantity of the electric power to output a detection signal to the control circuit;
a stop circuit capable of stopping/continuing output of the second detection circuit; and
a control section to detect existence of the output of the switch circuit to perform operation control of the stop circuit and the switch circuit, and wherein:
the first to third detection circuits are configured to displace their output values from a reference value when detection values pertaining to the output quantity of the power exceed respective set values of the first to third detection circuits, and the set values are set to satisfy the following relation:
(the set value of the first detection circuit)>(the set value of the second detection circuit)>(the set value of the third detection circuit).

11. The power source apparatus according to claim 10, wherein:
the control section stops the stop circuit to continue the output of the second detection circuit, and switches the switch circuit to a side of the third detection circuit when the output of the switch circuit does not exist, and
the control section makes the stop circuit operate to stop the output of the second detection circuit, and switches the switch circuit to a side of the first detection circuit when the output of the switch circuit exists.

12. The power source apparatus according to claim 1, further comprising a detection circuit for protection to perform detection pertaining to the output quantity of the electric power on the side of a main body in relation to the cable, wherein
the control circuit stops or lowers the output from the power source circuit when the detection circuit for protection detects the output quantity equal to or more than a predetermined output quantity.

13. The power source apparatus according to claim 1, wherein the detection pertaining to the output quantity indicates detection of a voltage or a current.

14. The power source apparatus according to claim 1, wherein the power source circuit is a switching power source circuit to perform output of electric power by turning on and off a switching element and to change the output quantity of the electric power by changing a switching frequency or an on-period of the switching element.

15. A power source apparatus comprising:
a power source circuit capable of changing a first output thereof;
a connector for supplying electric power relating to a second output based on the first output;
a cable connected between the power source circuit and the connector;
a control circuit to perform output control of the power source circuit; and
a first detection circuit connected to the cable on a side of the connector to perform detection pertaining to an output quantity of the power source apparatus to generate a detection signal, wherein
the control circuit performs the output control of the power source circuit based on the detection signal of the first detection circuit, by feeding back the detection signal to the control circuit.

16. The power source apparatus according to claim 5, further comprising:
a switch circuit to switch a connection of the input terminal for detection of the first detection circuit between the control connection terminal and wiring for power output; and
a connection detection circuit to detect a connection of the connector to the external apparatus, and wherein:
the input terminal for detection is switched to a side of the control connection terminal by the switch circuit when the connection of the external apparatus is detected, and the input terminal for detection is switched to the wiring for power output by the switch circuit when the connection of the external apparatus is not detected.

17. The power source apparatus according to claim 5, further comprising a second detection circuit to perform detection pertaining to the output quantity of the electric power on a side of a main body of the power source apparatus in relation to the cable, and wherein:
the control circuit performs the output control by using the detection signal of the first detection circuit with priority to a detection signal of the second detection circuit when the detection signal of the first detection circuit exists.

18. The power source apparatus according to claim 17, further comprising a switch circuit to transmit the detection signal of the first detection circuit to the control circuit when the detection signal of the first detection circuit exists, and to transmit the detection signal of the second detection circuit to the control circuit when the detection signal of the first detection circuit does not exists.

19. The power source apparatus according to claim 17, wherein the first detection circuit and the second detection circuit are configured to displace the detection signals from a reference value when detection values pertaining to the output quantity of the electric power exceed respective set values of the first and second detection circuits, and the set values of the first and second detection circuits are set to satisfy the following relation: (the set value of the first detection circuit)<(the set value of the second detection circuit).

20. The power source apparatus according to claim 5, further comprising:
a third detection circuit having an input terminal for detection, the input terminal connected to the control connection terminal;
a switch circuit to switch a connection of the control circuit between outputs of the first and third detection circuits selectively to transmit a selected output to the control circuit;
a second detection circuit to perform detection pertaining to the output quantity of the electric power to output a detection signal to the control circuit;
a stop circuit capable of stopping/continuing output of the second detection circuit; and
a control section to detect existence of the output of the switch circuit to perform operation control of the stop circuit and the switch circuit, and wherein:
the first to third detection circuits are configured to displace their output values from a reference value when detection values pertaining to the output quantity of the power exceed respective set values of the first to third detection circuits, and the set values are set to satisfy the following relation:
(the set value of the first detection circuit)>(the set value of the second detection circuit)>(the set value of the third detection circuit).

21. The power source apparatus according to claim 10, wherein:
the control section stops the stop circuit to continue the output of the second detection circuit, and switches the switch circuit to a side of the third detection circuit when the output of the switch circuit does not exist, and
the control section makes the stop circuit operate to stop the output of the second detection circuit, and switches the switch circuit to a side of the first detection circuit when the output of the switch circuit exists.
